(19) United States
(12) Patent Application Publication
(10) Pub. No.: US 2008/0034542 A1
(43) Pub. Date: Feb. 14, 2008

(54) Hinge with multiple lubricant grooves

(76) Inventor: Chung-Yu Lee, Shulin City (TW)

Correspondence Address: HERSHKOVITZ & ASSOCIATES, 2845 DUKE STREET, ALEXANDRIA, VA, 22314, US

(21) Appl. No.: 11/481,808

(22) Filed: Jul. 7, 2006

(51) Int. Cl. E05D 11/08

(52) U.S. Cl. 16/342

(57) ABSTRACT

A hinge has a stationary leaf, at least one barrel, a pivoting leaf and a pivot pin. The at least one barrel is formed on the stationary leaf and each has an inner surface, a pivot pin hole, a gap and an inner lubricant groove. The pivot pin hole is defined coaxially through the at least one barrel. The gap communicates with the pivot pin hole. The inner lubricant groove is defined in the inner surface. The pivot pin is protrudes from the pivoting bracket, is mounted rotatably in the pin hole in each of the at least one barrel and has multiple annular lubricant grooves communicating with the inner lubricant groove in each of the at least one barrel. The inner lubricant groove and the annular lubricant grooves hold sufficient lubricant to provide superior lubrication between the pivot pin hole and pivot pin.

### BACKGROUND OF THE INVENTION

1. Field of the Invention

The present invention relates to a hinge, and more particularly to a hinge with multiple lubricant grooves that can hold sufficient lubricant for the hinge to pivot smoothly.

2. Description of Related Art

Hinges are used generally to connect one object pivotally to another object.

A conventional hinge has a stationary leaf, a barrel, a pivoting leaf and a pivot pin. The stationary leaf is attached to a stationary object. The barrel is formed on the stationary leaf and has a pivot pin hole and an inner surface. The pivoting leaf is attached to a pivoting object. The pivot pin is formed on the pivoting bracket, is mounted rotatably in the pivot pin hole in the barrel and has an outer surface. To smoothly rotate the pivot pin in the pivot pin hole, lubricant is applied to the inner surface of the barrel and the outer surface of the pivot pin.

However, the space between the pivot pin hole and pivot pin only allows a little lubricant between the pivot pin hole and pivot pin. Therefore, lubrication between the pivot pin hole and pivot pin is insufficient. The lubricant is quickly squeezed out or consumed, and the engagement of the barrel and pivot pin becomes too tight to pivot the hinge.

To overcome the shortcomings, the present invention provides a hinge with multiple lubricant grooves to mitigate or obviate the aforementioned problems.

### SUMMARY OF THE INVENTION

The main objective of the invention is to provide a hinge with multiple lubricant grooves that can hold sufficient lubricant to smoothly pivot the hinge.

A hinge with multiple lubricant grooves in accordance with the present invention comprises a stationary leaf, at least one barrel, a pivoting leaf and a pivot pin.

The at least one barrel is formed on the stationary leaf and each has two ends, an inner surface, a pivot pin hole, a gap and an inner lubricant groove. The pivot pin hole is defined coaxially through the at least one barrel. The gap is formed through the barrel between the two ends and communicates with the two ends and the pivot pin hole. The inner lubricant groove is defined in the inner surface.

The pivot pin is formed on the pivoting bracket, is mounted rotatably in the pivot pin hole in each of the at least one barrel and has an outer surface and multiple annular lubricant grooves defined radially in the outer surface and communicating with the inner lubricant groove in each of the at least one barrel.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a hinge with multiple lubricant grooves in accordance with the present invention;

FIG. 2 is an exploded perspective view of the hinge in FIG. 1;

FIG. 3 is a plane projection of the outer surface of the pivot pin of the hinge in FIG. 2;

FIG. 4 is a plane projection of the inner surface of the barrel of the hinge in FIG. 2;

FIG. 5 is a perspective view of a pivoting leaf and a pivot pin of a second embodiment of a hinge in accordance with the present invention;

FIG. 6 is an exploded perspective view of a third embodiment of a hinge in accordance with the present invention;

FIG. 7 is a top view of the stationary leaf and the barrels of the hinge in FIG. 6 showing that each barrel spreads for illustration and has the inner lubricant groove being an X-shaped groove;

FIG. 8 is a top view of the stationary leaf and the barrels of the hinge in FIG. 6 showing that each barrel spreads for illustration and has the inner lubricant groove being an X-shaped groove with an annular groove around the X-shaped groove;

FIG. 9 a top view of the stationary leaf and the barrels of the hinge in FIG. 6 showing that each barrel spreads for illustration and has the inner lubricant groove being a Z-shaped groove;

FIG. 10 a top view of the stationary leaf and the barrels of the hinge in FIG. 6 showing that each barrel spreads for illustration and has the inner lubricant groove having multiple inclined sub-grooves; and

FIG. 11 a top view of the stationary leaf and the barrels of the hinge in FIG. 6 showing that each barrel spreads for illustration and has the inner lubricant groove being a 8-shaped groove.

### DETAILED DESCRIPTION OF THE PREFERRED EMBODIMENT

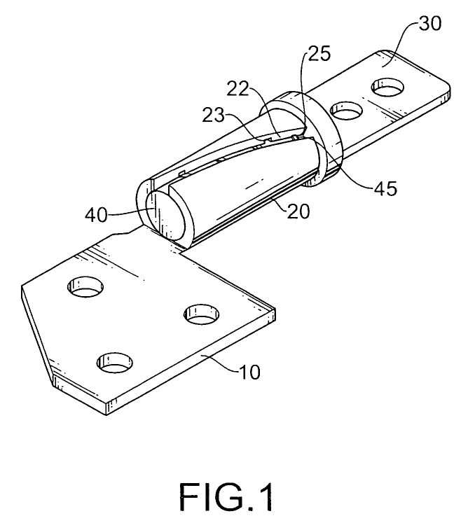

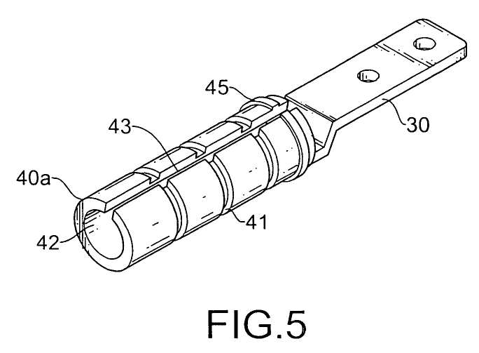

With reference to FIGS. 1 and 5, a hinge in accordance with the present invention connects a pivoting object such as a monitor to a stationary object such as a stand, allows the pivoting object to pivot relative to the stationary object and comprises a stationary leaf (10), at least one barrel (20), a pivoting leaf (30) and a pivot pin (40, 40a).

The stationary leaf (10) is attached to a stationary object such as a stand.

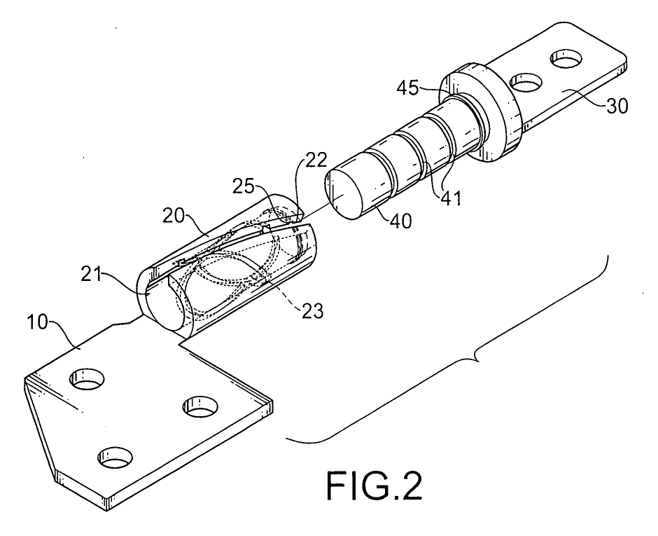

With further reference to FIG. 2, each of the at least one barrel (20) is formed on and extending from the stationary leaf (10) and has two ends, an inner surface, a pin hole (21), a gap (22), an inner lubricant groove (23) and an annular detent (25). The pivot pin hole (21) is defined coaxially through the barrel (20) and has a diameter. The gap (22) is formed through the barrel (20) between the two ends, communicates with the two ends and the pivot pin hole (21) and allows the barrel (20) to be squeezed to decrease the diameter of the pivot pin hole (21). Alternatively, the gap (22) can be expanded to increase the diameter of the pivot pin hole (21). With further reference to FIG. 4, the inner lubricant groove (23) is defined in the inner surface, may be a meandering lubricant groove appearing to be two intersecting sinusoidal grooves 180° out of phase when the inner surface is projected onto a plane and holds lubricant. The annular detent (25) is defined in the inner surface near the end opposite to the stationary leaf (10).

The pivoting leaf (30) is attached to a pivoting object such as a monitor.

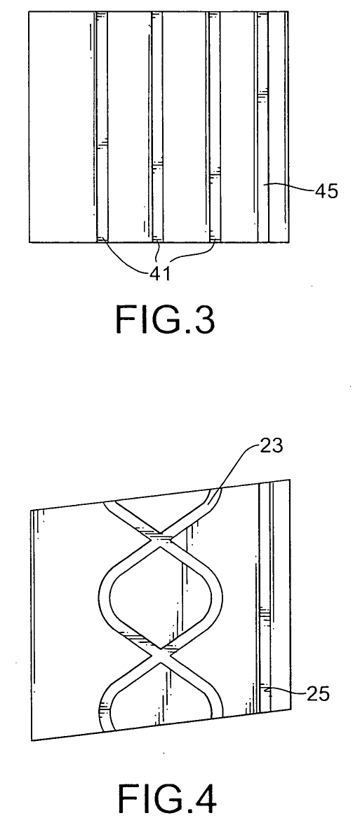

With further reference to FIG. 3, the pivot pin (40, 40a) is formed on and protrudes longitudinally from the pivoting leaf (30), may be solid or hollow, is mounted rotatably in the pivot pin hole (21) in each of the at least one barrel (20), has an outer surface, multiple annular lubricant grooves (41) and an annular outer rib (45). With further reference to FIG. 5, in an alternative embodiment, the pivot pin (40a) may have a central hole defined coaxially through the pivot pin (40a) and a gap defined through the pivot pin (40a) and communicating with the central hole when the pivot pin (40a) is hollow. The outer surface of the pivot pin (30) rotatably presses against the inner surface of each of the at least one barrel (20). With further reference to FIG. 3, the annular lubricant grooves (41) are defined radially in the outer surface at intervals, communicate with the inner lubricant groove (23) in each of the at least one barrel (20), appear to be multiple parallel grooves when the outer surface is projected onto a plane and hold lubricant in conjunction with the lubricant in the inner lubricant groove (23) to allow the pivot pin (40, 40a) to pivot smoothly in the at least one barrel (20). The annular outer rib (45) corresponds to and is mounted rotatably in the annular detent (25) in the corresponding barrel (20) to hold the pivot pin (40, 40a) safely in the at least one barrel (20).

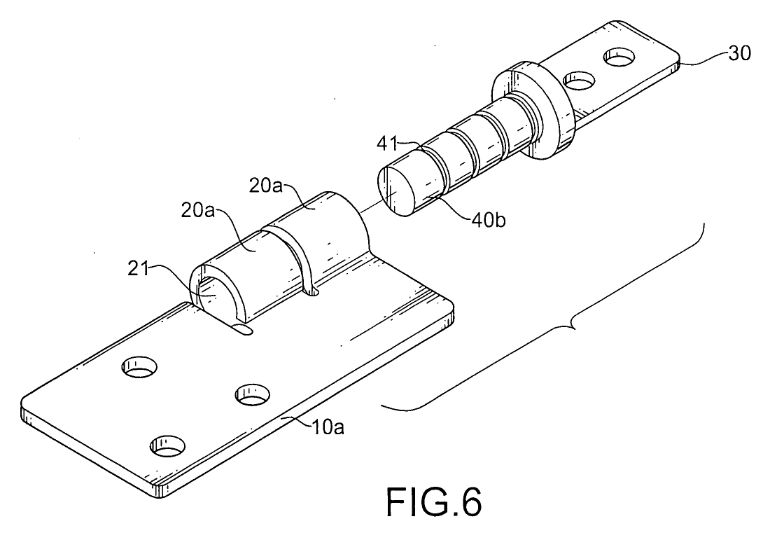

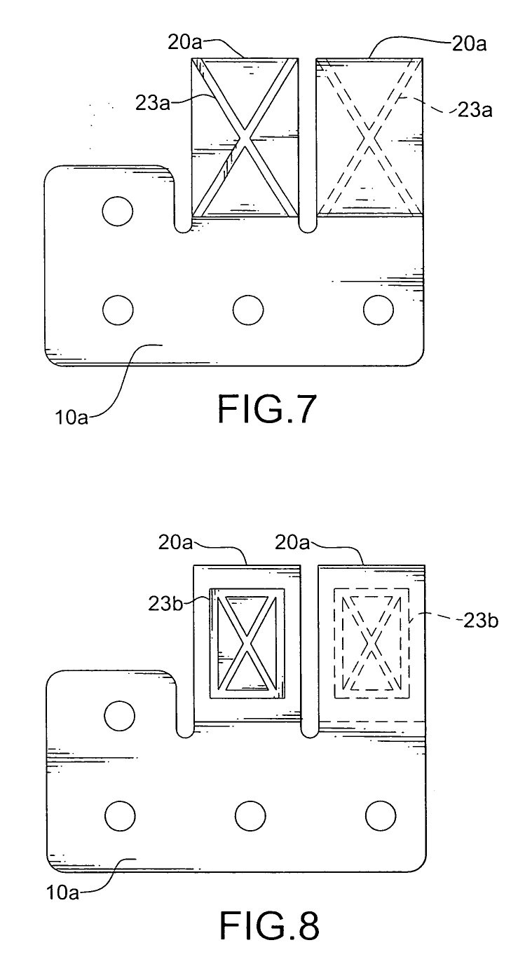

With reference to FIGS. 6 and 7, in an embodiment of the hinge in accordance with the present invention, a number of the at least one barrel (20a) is two and the two barrels (20a) are arranged abreast.

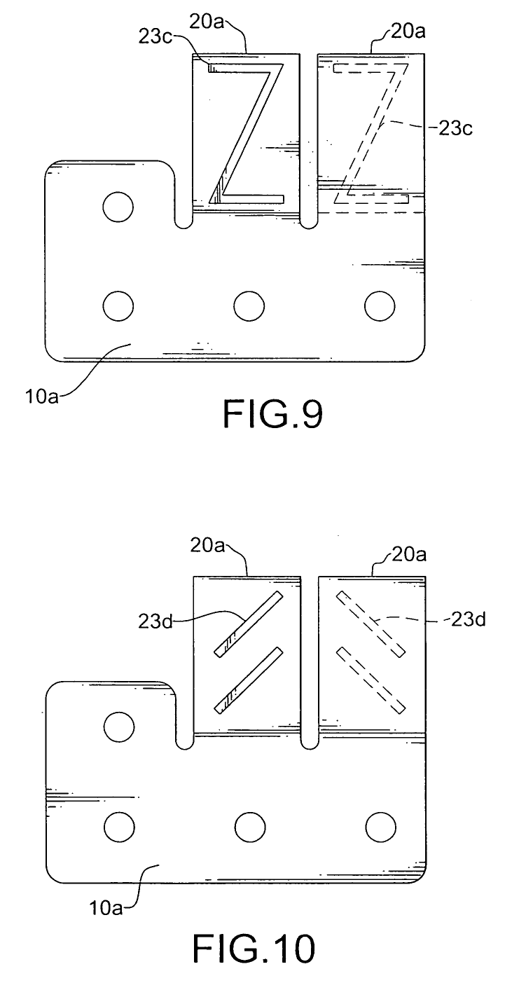

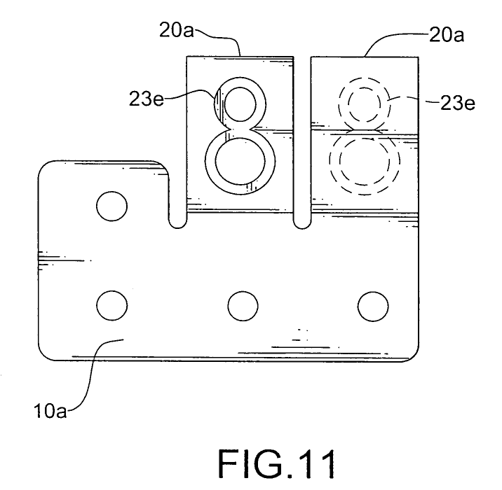

With reference to FIGS. 7-11, when the inner surface of each of the barrels (20a) is projected onto a plane, the inner lubricant groove (23a, 23b, 23c, 23d, 23e) in each barrel (20a) may be an X-shaped groove, may be an X-shaped groove with an annular groove around the X-shaped groove, may be a Z-shaped groove, may have multiple inclined sub-grooves and may be a 8-shaped groove.

The inner lubricant groove (23, 23a, 23b, 23c, 23d, 23e) in the barrel (20, 20a) and the annular lubricant grooves (41) in the pivot pin (40) receive sufficient lubricant to provide excellent superior lubricity between the pivot pin hole (21) and the pivot pin (40). Therefore, the hinge can pivot smoothly.

Even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A hinge with multiple lubricant grooves comprising:
a stationary leaf adapted for being attached to a stationary object;
at least one barrel being formed on and extending from the stationary leaf and each one of the at least one barrel having
two ends;
an inner surface;
a pivot pin hole defined coaxially through the barrel and having a diameter;
a gap being formed through the barrel between the two ends and communicating with the two ends and the pivot pin hole to allow the barrel to be squeezed or expanded respectively to decrease or increase the diameter of the pivot pin hole; and
an inner lubricant groove being defined in the inner surface;
a pivoting bracket adapted for being attached to a pivoting object; and
a pivot pin being formed on and protruding longitudinally from the pivoting bracket, being mounted rotatably in the pin hole in each one of the at least one barrel and having
an outer surface rotatably pressing against the inner surface of each one of the at least one barrel; and
multiple annular lubricant grooves being defined radially in the outer surface at intervals and communicating with the inner lubricant groove in each one of the at least one barrel to hold lubricant.

2. The hinge as claimed in claim 1, wherein the pivot pin is solid.

3. The hinge as claimed in claim 1, wherein the pivot pin is hollow and further has
a central hole defined coaxially through the pivot pin; and
a gap defined through the pivot pin and communicating with the central hole.

4. The hinge as claimed in 1, wherein:
the stationary leaf has one barrel, and the barrel further has an annular detent defined in the inner surface of the barrel near the end opposite to the stationary leaf; and
the pivot pin further has an annular outer rib corresponding to and mounted rotatably in the annular detent in the barrel.

5. The hinge as claimed in 1, wherein a number of the at least one barrel is two and the two barrels are arranged abreast.

6. The hinge as claimed in claim 1, wherein the inner lubricant groove in each one of the at least one barrel is a meandering lubricant groove appearing to be two sinusoidal grooves 180° out of phase when the surface is projected onto a plane.

7. The hinge as claimed in claim 5, wherein the inner lubricant groove in each one of the barrels is a meandering lubricant groove appearing to be two sinusoidal grooves 180° out of phase when the surface is projected onto a plane.

8. The hinge as claimed in claim 5, wherein the inner lubricant groove in each one of the barrels is an X-shaped groove when the inner surface of each barrel is projected onto a plane.

9. The hinge as claimed in claim 5, wherein the inner lubricant groove in each one of the barrel is an X-shaped groove with an annular groove around the X-shaped groove when the inner surface of each barrel is projected onto a plane.

10. The hinge as claimed in claim 5, wherein the inner lubricant groove in each one of the barrels is a Z-shaped groove when the inner surface of each barrel is projected onto a plane.

11. The hinge as claimed in claim 5, wherein the inner lubricant groove of each one of the barrels has multiple inclined sub-grooves when the inner surface of each barrel is projected onto a plane.

12. The hinge as claimed in claim 5, wherein the inner lubricant groove of each one of the barrels is an 8-shaped groove when the inner surface of each barrel is projected onto a plane.
